(19) United States
(12) Patent Application Publication
(10) Pub. No.: US 2012/0305744 A1
(43) Pub. Date: Dec. 6, 2012

(54) FAN MOUNTING APPARATUS FOR HEAT DISSIPATION

(75) Inventors: YUN-LUNG CHEN, Tu-Cheng (TW); DA-LONG SUN, Wuhan City (CN)

(73) Assignees: HON HAI PRECISION INDUSTRY CO., LTD., Tu-Cheng (TW); HONG FU JIN PRECISION INDUSTRY (WUHAN) CO., LTD., Wuhan City (CN)

(21) Appl. No.: 13/327,895

(22) Filed: Dec. 16, 2011

(30) Foreign Application Priority Data
May 31, 2011 (CN) 201110143651.2

(51) Int. Cl. F16M 13/02

(52) U.S. Cl. 248/672

(57) ABSTRACT

A fan mounting apparatus for a computer system comprises a chassis comprising a bottom plate and a rear plate substantially perpendicular to the bottom plate, a plurality of ventilation holes defined in the rear plate; at least two engaging members and a blocking portion extending from the rear plate, the at least two engaging members and the blocking portion being around the plurality of ventilation holes; a fan comprising a sidewall; wherein the at least two engaging members are mirror symmetry around the plurality of ventilation holes and engaged with the sidewall to prevent the fan from moving in a first direction, a second direction opposite to the first direction, and a third direction substantially perpendicular to the rear plate; and the blocking portion abuts the sidewall to prevent the fan from moving in a fourth direction substantially parallel to the rear plate.

### BACKGROUND

1. Technical Field

The present disclosure relates to fan mounting apparatuses, more particularly to a fan mounting apparatus for a computer system.

2. Description of Related Art

Computers generate a large amount of heat from electrical elements. A fan is often used as a conventional means to dissipate the heat from the computer. Typically, the fan is mounted to a computer case through a plurality of screws. However, such a mounting configuration of the fan may be inconvenient for a user. Therefore, an improved fan mounting apparatus for a computer system may be desired.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of a fan mounting apparatus in accordance with an embodiment.

FIG. 2 is an enlarged view of circled portion II of FIG. 1.

FIG. 3 is an assembled view of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

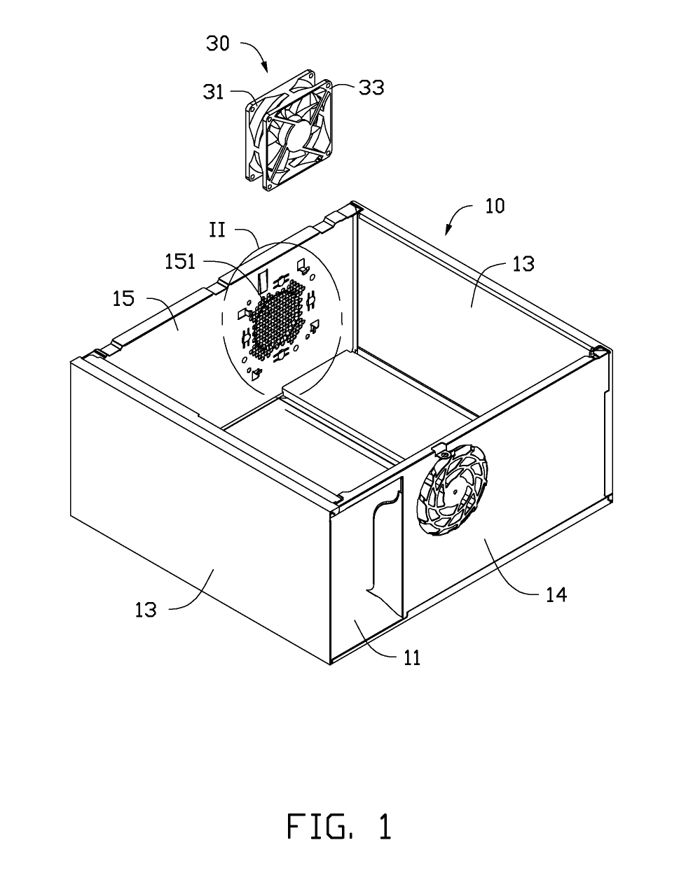

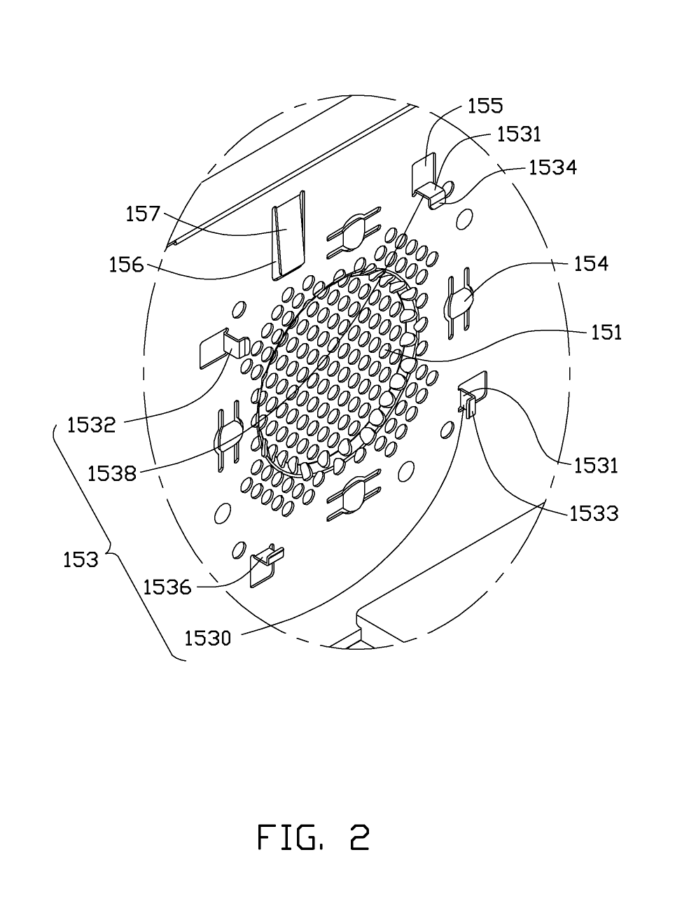

Referring to FIGS. 1 and 2, a mounting apparatus in accordance with an embodiment comprises a chassis 10 and a fan 30 received in the chassis 10. The fan 30 comprises a first sidewall 31 and a second sidewall 33 opposite to the first sidewall 31.

The chassis 10 comprises a bottom plate 11, two side plates 13 connected to opposite edges of the bottom plate 11, and a front plate 14 and a rear plate 15 connected to other opposite edges of the bottom plate 11. In one embodiment, the rear plate 15 is substantially perpendicular to the bottom plate 11.

A plurality of ventilation holes 151 are defined in the rear plate 15. In one embodiment, the plurality of ventilation holes 151 are arranged in a rectangle. Four engaging members 153 are located on the rear plate 15 and extend to an interior of the chassis 10. In one embodiment, the four engaging members 153 are arranged at the four corners of the rectangle formed by the plurality of ventilation holes 151.

Each of the four engaging members 153 comprises a connecting portion 1531 and an engaging portion 1533 substantially perpendicular to the connecting portion 1531.

In one embodiment, a tab 1534 extends from the engaging portion 1533. Four openings 155 are defined in the rear plate 15 and each of the four engaging members 153 extends from an edge of each of the four openings 155. In one embodiment, each of the four engaging members 153 has the same configuration, and the four engaging members 153 comprise a first engaging member 1530, a second engaging member 1532, a third engaging member 1536, and a fourth engaging member 1538. An extending direction of the engaging portion 1533 of the first engaging member 1530 is opposite to that of the engaging portion 1533 of the second engaging member 1532, so the first and second engaging members 1530, 1532 can engage with opposite edges of the first sidewall 31. An extending direction of the engaging portion 1533 of third engaging member 1536 is opposite to that of the engaging portion 1533 of the fourth engaging member 1538, so the third and fourth engaging members 1536, 1538 can engage with the other opposite edges of the first sidewall 31. In one embodiment, a first line connected to the first and second engaging members 1530, 1532 intersects a second line connected to the third and fourth engaging members 1536, 1538. In one embodiment, the first, second, third, fourth engaging members 1530, 1532, 1536, 1538 are arranged at four corners of a parallelogram; the parallelogram includes a first diagonal and a second diagonal intersects the first diagonal with a point of intersection. The engaging members 153, comprises at least two engaging members 153, are mirror symmetry with the point intersection.

Two protruding portions 154 are located on the rear plate 15, and each of the two protruding portions 154 is located between two of the four engaging members 153. A hole 156 is defined in the rear plate 15 and above the plurality of ventilation holes 151. A blocking portion 157 extends from an edge of the hole 156 and an acute angle is defined between the blocking portion 157 and the rear plate 15. In one embodiment, the blocking portion 157 is an elastic piece.

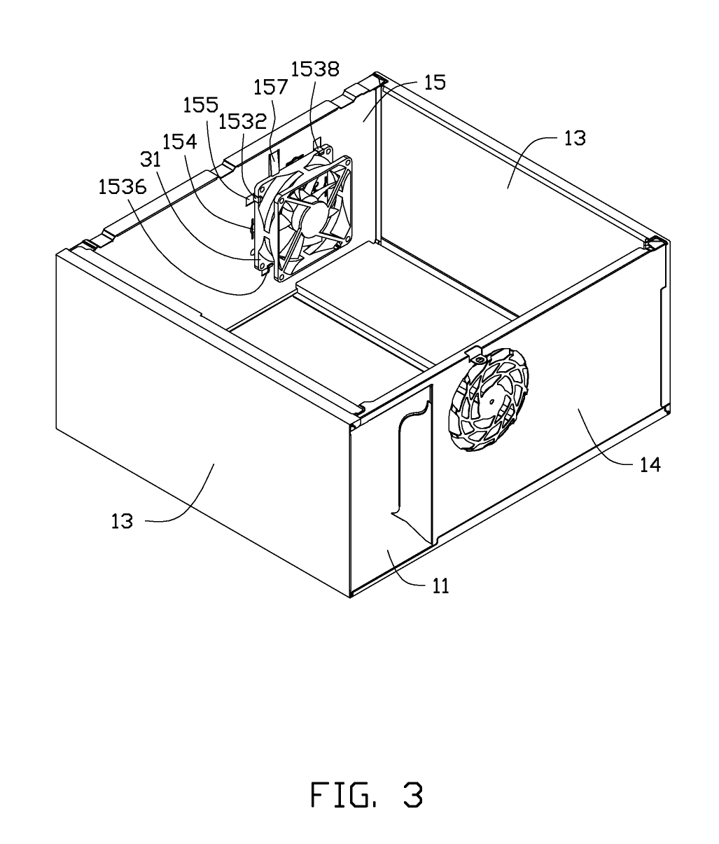

Referring FIG. 3, in assembly, the fan 30 is aligned with the plurality of ventilation holes 151 to be received the four engaging members 153, and the fan 30 is slanted relative to the rear plate 15. The fan 30 is rotated in anticlockwise until blocked by the blocking portion 157, and the four edges of the sidewall 31 are engaged with the four engaging members 153. Therefore, the first and second engaging members 1530, 1532 can prevent the fan 30 from moving in right and left, and the third and fourth engaging members 1536, 1538 can prevent the fan 30 from moving upward and downward. In this position, each engaging portion 1533 is clipped with the first sidewall 31 to prevent the fan 30 from moving away the rear plate 15 in a direction substantially perpendicular to the rear plate 15. The blocking portion 157 abuts on a top edge of the first sidewall 31, and the first sidewall 31 abuts the two protruding portions 154.

In disassembly, the blocking portion 157 is pressed to be deformed in a direction substantially perpendicular to the rear plate 15, disengaging from the first sidewall 31. The fan 30 is rotated in clockwise disengaging the four engaging members 153 from the first sidewall 31. Therefore, the fan 30 can be detached from the rear plate 15.

It is to be understood, however, that even though numerous characteristics and advantages have been set forth in the foregoing description of embodiments, together with details of the structures and functions of the embodiments, the disclosure is illustrative only and changes may be made in detail, especially in matters of shape, size, and arrangement of parts within the principles of the disclosure to the full extent indicated by the broad general meaning of the terms in which the appended claims are expressed.

What is claimed is:

1. A fan mounting apparatus comprising:
a chassis comprising a bottom plate and a rear plate substantially perpendicular to the bottom plate, a plurality of ventilation holes defined in the rear plate; at least two engaging members and a blocking portion extending from the rear plate, the at least two engaging members and the blocking portion being around the plurality of ventilation holes;
a fan comprising a sidewall;
wherein the at least two engaging members are mirror symmetry around the plurality of ventilation holes and engaged with the sidewall to prevent the fan from moving in a first direction, a second direction opposite to the first direction, and a third direction substantially perpendicular to the rear plate; and the blocking portion abuts the sidewall to prevent the fan from moving in a fourth direction substantially parallel to the rear plate.

2. The fan mounting apparatus of claim 1, wherein the blocking portion is an elastic piece.

3. The fan mounting apparatus of claim 1, wherein a hole is defines in the rear plate, the blocking portion extends from an edge of the hole, and an acute angle is defined between the rear plate and the blocking portion.

4. The fan mounting apparatus of claim 1, wherein each of the at least two engaging members is substantially perpendicular to the rear plate.

5. The fan mounting apparatus of claim 4, wherein each of the at least two engaging members comprises a connecting portion connected to the rear plate and an engaging portion connected to the connecting portion, and the engaging portion is substantially perpendicular to connecting portion.

6. The fan mounting apparatus of claim 1, wherein the rear plate comprises at least two openings, and each of the at least two engaging members extends from each of the at least two openings.

7. The fan mounting apparatus of claim 1, wherein the at least two engaging members comprises a first engaging member, a second engaging member, a third engaging member and a fourth engaging member; the first engaging member and the second engaging member are engaged with a first opposite edges of the sidewall, and the third engaging member and the fourth engaging member are engaged with a second opposite edges of the sidewall.

8. The fan mounting apparatus of claim 7, wherein a line connecting the first engaging member and the second engaging member intersects with a line connecting the third engaging member and the fourth engaging member.

9. The fan mounting apparatus of claim 7, wherein a protruding portion is located between two of the first, second, third, and fourth engaging members, and the protruding portion abuts the sidewall of the fan.

10. A fan mounting apparatus comprising:
a chassis comprising a rear plate, a plurality of ventilation holes defined in the rear plate; the at least two engaging members being mirror symmetry around the plurality of ventilation holes;
a fan comprising a sidewall attached to the rear plate;
wherein the fan is attached to the chassis by rotating the fan relative to the rear plate, and engaging the sidewall with the at least two engaging members, and the blocking portion abuts the sidewall to prevent the fan from moving away from the rear plate.

11. The fan mounting apparatus of claim 10, wherein the blocking portion is an elastic piece.

12. The fan mounting apparatus of claim 10, wherein a hole is defines in the rear plate, the blocking portion extends from an edge of the hole, and an acute angle is defined between the rear plate and the blocking portion.

13. The fan mounting apparatus of claim 10, wherein each of the at least two engaging members is substantially perpendicular to the rear plate.

14. The fan mounting apparatus of claim 13, wherein each of the at least two engaging members comprises a connecting portion connected to the rear plate and an engaging portion connected to the connecting portion, and the engaging portion is substantially perpendicular to connecting portion.

15. The fan mounting apparatus of claim 10, wherein the rear plate comprises at least two openings, and each of the at least two engaging members extends from each of the at least two openings.

16. The fan mounting apparatus of claim 10, wherein the at least two engaging members comprises a first engaging member, a second engaging member, a third engaging member and a fourth engaging member; the first engaging member and the second engaging member are engaged with a first opposite edges of the sidewall, and the third engaging member and the fourth engaging member are engaged with a second opposite edges of the sidewall.

17. The fan mounting apparatus of claim 16, wherein a line connecting the first engaging member and the second engaging member intersects with a line connecting the third engaging member and the fourth engaging member.

18. The fan mounting apparatus of claim 16, wherein a protruding portion is located between two of the first, second, third, and fourth engaging members, and the protruding portion abuts the sidewall of the fan.

19. The fan mounting apparatus of claim 16, wherein the first engaging member, the second engaging member, the third engaging member, and the fourth engaging member are arranged at four corners of a parallelogram.
